(19) United States
(12) Patent Application Publication
(10) Pub. No.: US 2021/0097731 A1
(43) Pub. Date: Apr. 1, 2021

(54) PRESENTING ENVIRONMENT BASED ON PHYSICAL DIMENSION

(71) Applicant: Apple Inc., Cupertino, CA (US)

(72) Inventor: Payal Jotwani, Santa Clara, CA (US)

(21) Appl. No.: 16/987,805

(22) Filed: Aug. 7, 2020

Related U.S. Application Data
(60) Provisional application No. 62/906,659, filed on Sep. 26, 2019.

(51) Int. Cl. G06T 11/00; G06K 9/00; G06T 7/60; G06F 16/53; G06F 16/58

(52) U.S. Cl. CPC G06T 11/00; G06K 9/00664; G06F 16/5866; G06F 16/53; G06T 7/60

(57) ABSTRACT

Various implementations disclosed herein include devices, systems, and methods for generating a dimensionally accurate computer-generated reality (CGR) environment with a scaled CGR object. In some implementations, a method includes obtaining environmental data corresponding to a physical environment. A known physical article located within the physical environment is identified based on the environmental data. The known physical article is associated with a known dimension. A physical dimension of the physical environment is determined based on the known dimension of the known physical article. A CGR environment is generated that represents the physical environment. A virtual dimension of the CGR environment is a function of the physical dimension of the physical environment.

### CROSS REFERENCE TO RELATED APPLICATIONS

This application claims priority to U.S. patent application No. 62/906,659, filed on Sep. 26, 2019, which is hereby incorporated by reference in its entirety.

### TECHNICAL FIELD

The present disclosure generally relates to rendering of computer-generated reality (CGR) environments and objects.

### BACKGROUND

Some devices are capable of generating and presenting computer-generated reality (CGR) environments. Some CGR environments include virtual environments that are simulated replacements of physical environments. Some CGR environments include augmented environments that are modified versions of physical environments. Some devices that present CGR environments include mobile communication devices, such as smartphones, head-mountable displays (HMDs), eyeglasses, heads-up displays (HUDs), and optical projection systems.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1A illustrates an exemplary operating environment in accordance with some implementations.

FIG. 1B illustrates another exemplary operating environment in accordance with some implementations.

FIG. 2 illustrates an example system that generates a CGR environment according to various implementations.

FIG. 3 is a block diagram of an example CGR content module in accordance with some implementations.

FIGS. 4A-4C are a flowchart representation of a method for generating a CGR environment in accordance with some implementations.

FIG. 5 is a block diagram of a device in accordance with some implementations.

FIG. 6 illustrates an example system that displays a CGR object in an augmented reality (AR) environment according to various implementations.

FIG. 7 is a block diagram of an example CGR content module in accordance with some implementations.

FIGS. 8A-8C are a flowchart representation of a method for displaying a CGR object in an AR environment in accordance with some implementations.

FIG. 9 is a block diagram of a device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for generating a dimensionally accurate computer-generated reality (CGR) environment with a scaled CGR object. In some implementations, a method includes obtaining environmental data corresponding to a physical environment. A known physical article located within the physical environment is identified based on the environmental data. The known physical article is associated with a known dimension. A physical dimension of the physical environment is determined based on the known dimension of the known physical article. A CGR environment is generated that represents the physical environment. A virtual dimension of the CGR environment is a function of the physical dimension of the physical environment.

Various implementations disclosed herein include devices, systems, and methods for instantiating a CGR object in an augmented reality (AR) environment and scaling the CGR object based on dimension information associated with the CGR object and a known dimension of a known physical article. In some implementations, a method includes displaying an AR environment that corresponds to a physical environment. It is determined to display a CGR object in the AR environment. The CGR object represents a physical article associated with a physical dimension. A known physical article located within the physical environment is identified. The known physical article is associated with a known dimension. A virtual dimension for the CGR object is determined based on the known dimension of the known physical article and the physical dimension of the physical article that the CGR object represents. The CGR object is displayed in the AR environment in accordance with the virtual dimension.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### Description

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

The present disclosure provides methods, systems, and/or devices for generating a dimensionally accurate computer-generated reality (CGR) environment with a scaled CGR object. In some implementations, a method includes obtaining environmental data corresponding to a physical environment. A known physical article located within the physical environment is identified based on the environmental data. The known physical article is associated with a known dimension. A physical dimension of the physical environment is determined based on the known dimension of the known physical article. A CGR environment is generated that represents the physical environment. A virtual dimension of the CGR environment is a function of the physical dimension of the physical environment.

In some implementations, a device generates and presents computer-generated reality (CGR) content that includes a CGR environment with virtual dimensions that are proportional to physical dimensions of a physical environment. In some implementations, based on sensor information, a controller detects a physical object in the physical environment and obtains the dimensions of the physical object, e.g., by searching a database that includes information regarding the physical object. In some implementations, the controller generates a semantic construction of the physical environment. The semantic construction may include a CGR representation of the physical object with virtual dimensions that are proportional to the physical dimensions of the physical object. In some implementations, if a detected physical object is within a degree of similarity to a physical object of a known size, the controller uses the known size of the physical object to determine relative sizes of other physical objects and the physical environment based on the sensor information.

The present disclosure provides methods, systems, and/or devices for instantiating a CGR object in an augmented reality (AR) environment and scaling the CGR object based on dimension information associated with the CGR object and a known dimension of a known physical article. In some implementations, a method includes displaying an AR environment that corresponds to a physical environment. It is determined to display a CGR object in the AR environment. The CGR object represents a physical article associated with a physical dimension. A known physical article located within the physical environment is identified. The known physical article is associated with a known dimension. A virtual dimension for the CGR object is determined based on the known dimension of the known physical article and the physical dimension of the physical article that the CGR object represents. The CGR object is displayed in the AR environment in accordance with the virtual dimension.

In some implementations, a CGR object in an augmented reality (AR) environment is scaled based on a known dimension of a known physical article. For example, an electrical outlet may be identified in an AR environment corresponding to a living room. Electrical outlets are governed by a standard and have a known height (e.g., 4 inches or approximately 10 centimeters). In some implementations, a CGR object, such as a chair, is scaled based on the electrical outlet. More generally, a CGR object may be scaled based on one or more of a known dimension of a known physical article, a distance of the known physical article from a device, a dimension of a physical article corresponding to the CGR object, and/or a distance at which the CGR object is to be placed.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR Include Virtual Reality and Mixed Reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of Mixed Realities Include Augmented Reality and Augmented Virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one implementation, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

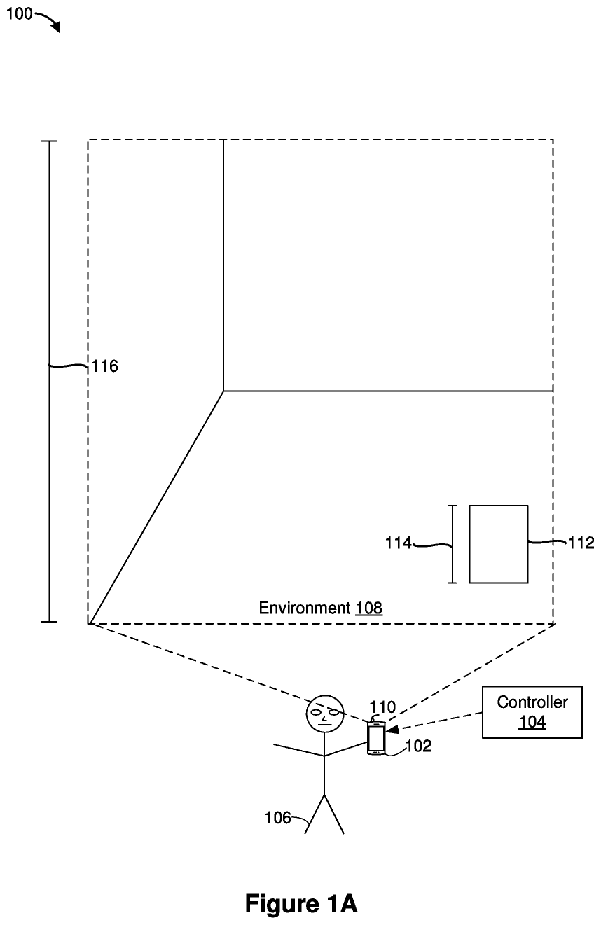

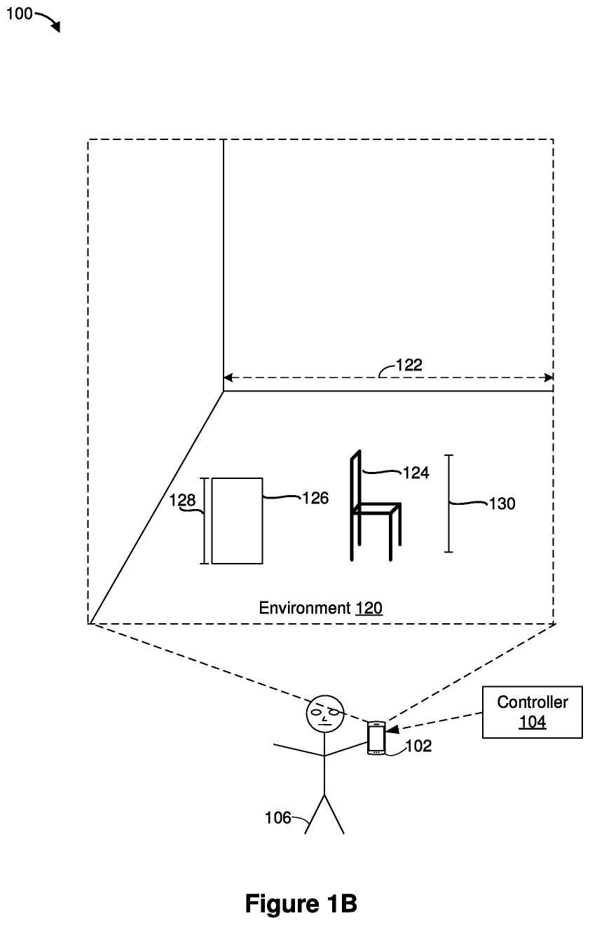

FIG. 1A illustrates an exemplary operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes an electronic device 102 and a controller 104. In some implementations, the electronic device 102 is or includes a smartphone, a tablet, a laptop computer, and/or a desktop computer. The electronic device 102 may be worn by or carried by a user 106.

As illustrated in FIG. 1A, the electronic device 102 and/or the controller 104 obtains (e.g., receives, retrieves, and/or detects) environmental data corresponding to a physical environment 108. For example, the environmental data may include an image or a video captured by an image sensor 110, such as a camera. In some implementations, the environmental data includes depth information captured by a depth sensor.

In some implementations, the electronic device 102 and/or the controller 104 identifies a known physical article 112 in the physical environment 108 based on the environmental data. For example, in some implementations, the electronic device 102 and/or the controller 104 perform semantic segmentation and/or instance segmentation on the environmental data to detect the known physical article 112. In some implementations, the electronic device 102 and/or the controller 104 identify an optical machine-readable representation (e.g., a barcode or a QR code) of data associated with the physical article. The optical machine-readable representation of data may be used to identify the known physical article 112.

The known physical article 112 is associated with a known dimension 114 (e.g., a height, a length, a width, a volume and/or an area of the known physical article 112). In some implementations, the electronic device 102 and/or the controller 104 determine (e.g., estimate) a physical dimension 116 of the physical environment 108 (e.g., a height, a length, a width, a volume and/or an area of the physical environment 108) based on the known dimension 114. In some implementations, the electronic device 102 and/or the controller 104 obtain the known dimension 114, e.g., from a datastore or via a network. In some implementations, the electronic device 102 and/or the controller 104 perform an image search based on a portion of the environmental data that corresponds to the known physical article 112. In some implementations, the electronic device 102 and/or the controller 104 determine the physical dimension 116 based on the known dimension 114 and a proportion of the known physical article 112 to the physical environment 108.

Referring now to FIG. 1B, in some implementations, the electronic device 102 and/or the controller 104 may present a computer-generated reality (CGR) environment 120 that represents the physical environment 108. In some implementations, the CGR environment 120 includes a virtual environment that is a simulated replacement of the physical environment 108. For example, the CGR environment 120 may be simulated by the electronic device 102 and/or the controller 104. In such implementations, the CGR environment 120 is different from the physical environment 108 in which the electronic device 102 is located.

In some implementations, the CGR environment 120 includes an augmented environment that is a modified version of the physical environment 108. For example, in some implementations, the electronic device 102 and/or the controller 104 modify (e.g., augment) the physical environment 108 in which the electronic device 102 is located in order to generate the CGR environment 120. In some implementations, the electronic device 102 and/or the controller 104 generate the CGR environment 120 by simulating a replica of the physical environment 108 in which the electronic device 102 is located. In some implementations, the electronic device 102 and/or the controller 104 generate the CGR environment 120 by removing and/or adding items from the simulated replica of the physical environment 108 in which the electronic device 102 is located.

In some implementations, the CGR environment 120 is associated with a virtual dimension 122 (e.g., a height, a length, a width, a volume and/or an area of the CGR environment 120). In some implementations, the virtual dimension 122 is a function of the physical dimension 116 of the physical environment 108. For example, the virtual dimension 122 is proportional to the physical dimension 116 (e.g., a ratio between a physical height and a physical width of the physical environment 108 is approximately the same as a ratio between a virtual height and a virtual width of the CGR environment 120).

In some implementations, the CGR environment 120 is an augmented reality (AR) environment that corresponds to the physical environment 108. For example, the CGR environment 120 may be rendered as an optical pass-through of the physical environment 108 in which one or more CGR objects are rendered with the physical environment 108 as a background, e.g., overlaid over the physical environment. In some implementations, the image sensor 110 obtains image data corresponding to the physical environment 108, and the CGR environment 120 is rendered as a video pass-through of the physical environment 108. In a video pass-through, the electronic device 102 and/or the controller 104 display one or more CGR objects with a CGR representation of the physical environment 108.

In some implementations, the electronic device 102 and/or the controller 104 determine to display a CGR object 124 in the CGR environment 120. The CGR object 120 represents a physical article associated with a physical dimension. For example, the electronic device 102 and/or the controller 104 may determine to display a CGR chair that represents a physical chair that is associated with a physical dimension, e.g., a height of the physical chair.

In some implementations, the electronic device 102 and/or the controller 104 identify a known physical article 126 in the physical environment 108. The known physical article 126 may be the same physical article as the known physical article 112 shown in FIG. 1A or may be a different physical article. The known physical article 126 is associated with a known dimension 128. For example, if the known physical article 126 is an electrical outlet, the electronic device 102 and/or the controller 104 may determine that electrical outlets have a known height (e.g., 4 inches or approximately 10 centimeters, for example, as defined by a standard published by a standards body such as the National Electrical Code (NEC)). In some implementations, the electronic device 102 and/or the controller 104 obtain the known dimension 128 from a datastore or via a network.

In some implementations, the electronic device 102 and/or the controller 104 determine a virtual dimension 130 of the CGR object 124 based on the known dimension 128 and the physical dimension of the physical article that the CGR object 124 represents. For example, if the CGR object 124 represents a chair, the virtual dimension 130 may be a height of the CGR object 124. The electronic device 102 and/or the controller 104 may determine the height of the CGR object 124 based on the height of an electrical outlet in the physical environment 108 and the height of a physical chair that the CGR object 124 represents.

In some implementations, a head-mountable device (HMD), being worn by the user 106, presents (e.g., displays) the computer-generated reality (CGR) environment 120 according to various implementations. In some implementations, the HMD includes an integrated display (e.g., a built-in display) that displays the CGR environment 120. In some implementations, the HMD includes a head-mountable enclosure. In various implementations, the head-mountable enclosure includes an attachment region to which another device with a display can be attached. For example, in some implementations, the electronic device 102 of FIG. 1A can be attached to the head-mountable enclosure. In various implementations, the head-mountable enclosure is shaped to form a receptacle for receiving another device that includes a display (e.g., the electronic device 102). For example, in some implementations, the electronic device 102 slides or snaps into or otherwise attaches to the head-mountable enclosure. In some implementations, the display of the device attached to the head-mountable enclosure presents (e.g., displays) the CGR environment 120. In various implementations, examples of the electronic device 104 include smartphones, tablets, media players, laptops, etc.

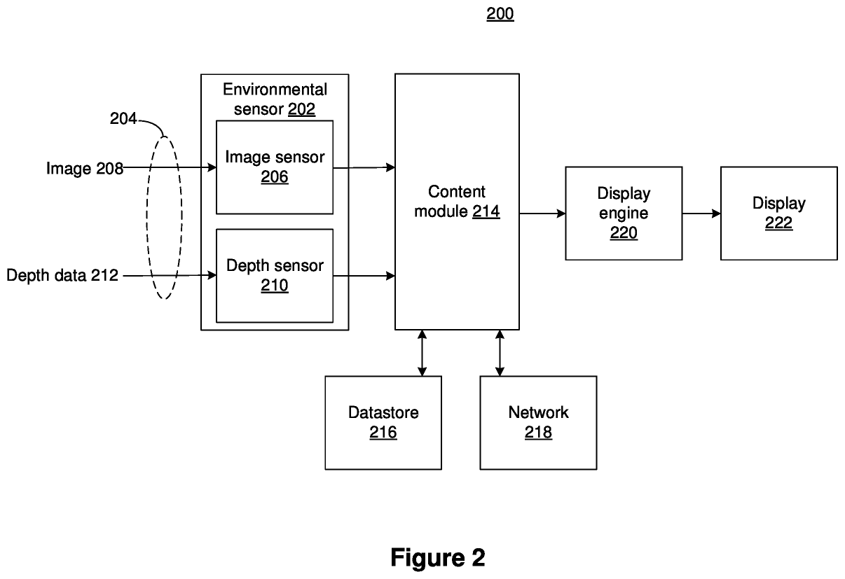

FIG. 2 illustrates an example system 200 that generates a CGR environment according to various implementations. In some implementations, an environmental sensor 202 obtains environmental data 204 corresponding to a physical environment. For example, in some implementations, the environmental sensor 202 comprises an image sensor 206, such as a camera, that obtains an image 208 of the environment.

In some implementations, the image 208 is a still image. In some implementations, the image 208 is an image frame forming part of a video feed. The image 208 includes a plurality of pixels. Some of the pixels, e.g., a first set of pixels, represent an object. Other pixels, e.g., a second set of pixels, represent a background, e.g., portions of the image 208 that do not represent the object. It will be appreciated that pixels that represent one object may represent the background for a different object.

In some implementations, the environmental sensor 202 comprises a depth sensor 210 that obtains depth data 212 corresponding to the physical environment. The depth data 212 may be used independently of or in connection with the image 208 to identify one or more objects in the physical environment.

In some implementations, a CGR content module 214 receives the environmental data 204 from the environmental sensor 202. In some implementations, the CGR content module 214 identifies a known physical article in the physical environment based on the environmental data 204. For example, the CGR content module 214 may perform semantic segmentation and/or instance segmentation on the environmental data 204 to identify the known physical article. In some implementations, the environmental data 204 includes an image, and the CGR content module 214 applies one or more filters and/or masks to the image to characterize pixels in the image as being associated with respective objects, such as the known physical article.

In some implementations, the image 208 includes an optical machine-readable representation (e.g., a barcode or a QR code) of data associated with the known physical article. The CGR content module 214 may send a query, e.g., to a product database to obtain information identifying the known physical article.

The known physical article is associated with a known dimension. In some implementations, the CGR content module 214 obtains dimension information for the known physical article. For example, the CGR content module 214 may send a query including information identifying the known physical article to a datastore 216 or to a service via a network 218, such as a local area network (LAN) or the Internet. In some implementations, the information identifying the known physical article includes a semantic label, a product identifier, and/or an image. In response to the query, the CGR content module 214 may receive dimension information for the known physical article. In some implementations, if dimension information for the known physical article is not available, the CGR content module 214 receives dimension information for a physical article that is within a degree of similarity to the known physical article.

In some implementations, the CGR content module 214 determines a physical dimension of the physical environment based on the known dimension of the known physical article. In some implementations, the CGR content module 214 determines the physical dimension of the physical environment based on the known dimension (e.g., the dimension information received in response to the query) of the known physical article and a proportion of the known physical article to the physical environment. For example, if the CGR content module 214 identifies the known physical article as a desk having a known width of two meters and the desk occupies half of the length of a wall, the CGR content module 214 may determine that the wall is four meters long.

In some implementations, the CGR content module 214 generates a CGR environment that represents the physical environment. The CGR environment is associated with a virtual dimension that is a function of the physical dimension of the physical environment. The CGR content module 214 may provide the CGR environment to a display engine 220, which prepares the CGR environment for output using a display 222.

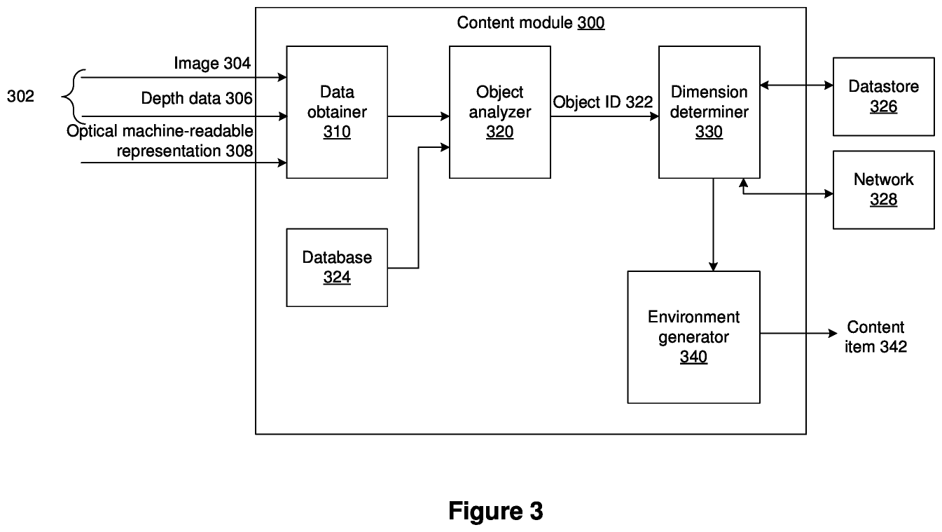

FIG. 3 is a block diagram of an example CGR content module 300 in accordance with some implementations. In some implementations, the CGR content module 300 implements the CGR content module 214 shown in FIG. 2. A data obtainer 310 may obtain environmental data 302 corresponding to a physical environment.

In some implementations, the environmental data 302 includes an image 304. In some implementations, the image 304 is a still image. In some implementations, the image 304 is an image frame forming part of a video feed. The image 304 includes a plurality of pixels. Some of the pixels, e.g., a first set of pixels, represent an object. Other pixels, e.g., a second set of pixels, represent a background, e.g., portions of the image 304 that do not represent the object. It will be appreciated that pixels that represent one object may represent the background for a different object.

In some implementations, the environmental data 302 includes depth data 306 corresponding to the physical environment. The depth data 306 may be used independently of or in connection with the image 304 to identify one or more objects in the physical environment.

In some implementations, the data obtainer 310 may obtain an optical machine-readable representation 308 of data associated with a physical article. The optical machine-readable representation 308 may be implemented, for example, as a barcode or a QR code. In some implementations, the optical machine-readable representation 308 is part of the image 304. In some implementations, the optical machine-readable representation 308 is captured separately from the image 304.

In some implementations, an object analyzer 320 identifies a known physical article in the physical environment based on one or more of the image 304, the depth data 306, and/or the optical machine-readable representation 308. In some implementations, the object analyzer 320 performs semantic segmentation and/or instance segmentation on the environmental data 302 (e.g., the image 304) to identify the known physical article. In some implementations, the known physical article is represented by a portion of the image 304, and the object analyzer 320 performs semantic segmentation and/or instance segmentation on that portion of the image 304 to identify the known physical article.

In some implementations, the object analyzer 320 determines an object identifier 322, such as a semantic label and/or a product identifier, that identifies the known physical article. In some implementations, the object analyzer 320 determines the object identifier 322 for the known physical article based on available information relating to a physical article corresponding to the known physical article or within a degree of similarity to the known physical article. This information can be obtained from one or more sources.

For example, in some implementations, the object analyzer 320 determines the object identifier 322 based on information received from a database 324 (e.g., a local database). For example, the database 324 may store a product specification for a physical article (e.g., a chair) corresponding to the known physical article (e.g., of the same model of the known physical article). In some implementations, the database 324 stores a product specification for a physical article that is within a degree of similarity to (e.g., within a similarity threshold of) the known physical article. For example, if a product specification is not available for the same model of chair corresponding to the known physical article, the object analyzer 320 may use a product specification for a similar model of chair.

In some implementations, a dimension determiner 330 receives the object identifier 322 and determines a known dimension of the known physical article. In some implementations, the dimension determiner 330 obtains dimension information for the known physical article. For example, the dimension determiner 330 may send a query to a datastore 326 or to a service accessible via a network 328 (e.g., a local area network or the Internet). The datastore 326 may store dimension information for a plurality of known physical articles.

The query may include information that identifies the known physical article, such as the object identifier 322 or an image of the known physical article. In response to the query, the dimension determiner 330 may receive dimension information for the known physical article. In some implementations, if dimension information for the known physical article is not available, the dimension determiner 330 receives dimension information for a physical article that is within a degree of similarity to the known physical article. For example, if the known physical article is a chair and the datastore 326 does not store dimension information for the same model of chair corresponding to the known physical article, the dimension determiner 330 may instead receive dimension information for a similar model of chair.

In some implementations, the dimension determiner 330 determines a physical dimension of the physical environment based on the known dimension of the known physical article. In some implementations, the dimension determiner 330 determines the physical dimension of the physical environment based on the known dimension and a proportion of the known physical article to the physical environment. For example, the known physical article may be a desk located along a wall of an office, and the known dimension of the desk may be a width of two meters. If the proportion of the width of the desk to the wall is 1:2 (e.g., the desk occupies half of the wall along which the desk is located), the dimension determiner 330 may determine that the wall along which the desk is located is four meters long. In some implementations, the dimension determiner 330 determines other physical dimensions of the physical environment based on this determination. For example, if the height of the wall is three-fourths of the length of the wall, the dimension determiner 330 may determine that the wall is three meters high.

In some implementations, an environment generator 340 generates a CGR environment that represents (e.g., models) the physical environment. In some implementations, the CGR environment is a computer-generated model of the physical environment. The CGR environment may be output as part of a CGR content item 342, which may also include one or more CGR objects. In some implementations, the CGR environment has a virtual dimension, e.g., a number of pixels. The virtual dimension is a function of the physical dimension of the physical environment. For example, in some implementations, the environment generator 340 determines a number of pixels to use in rendering the physical dimension of the physical environment.

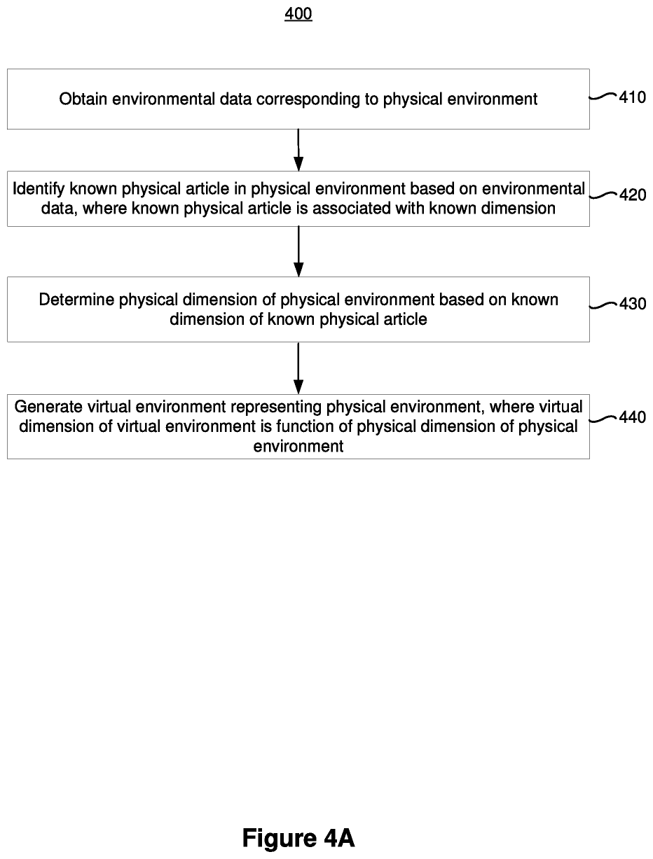

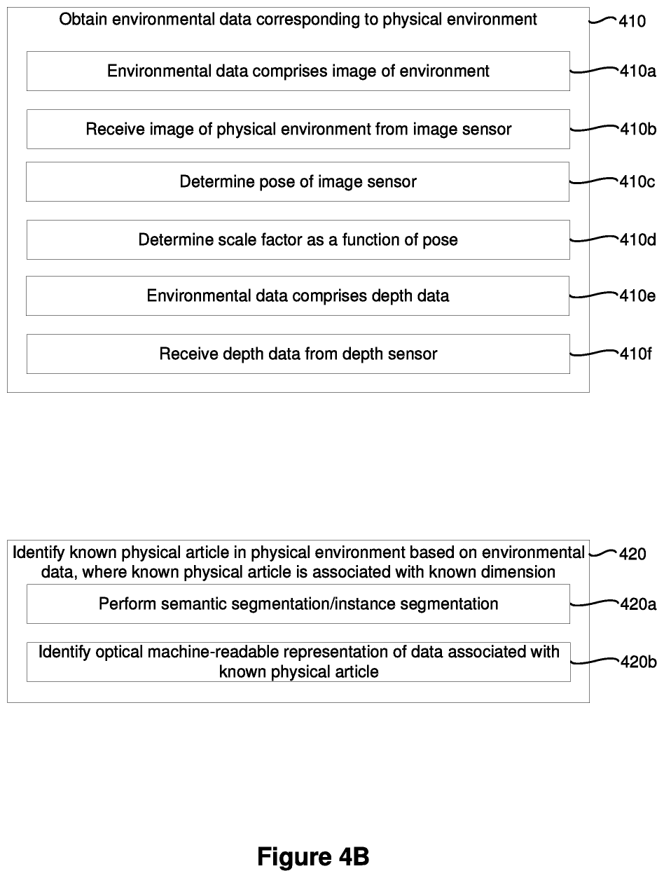

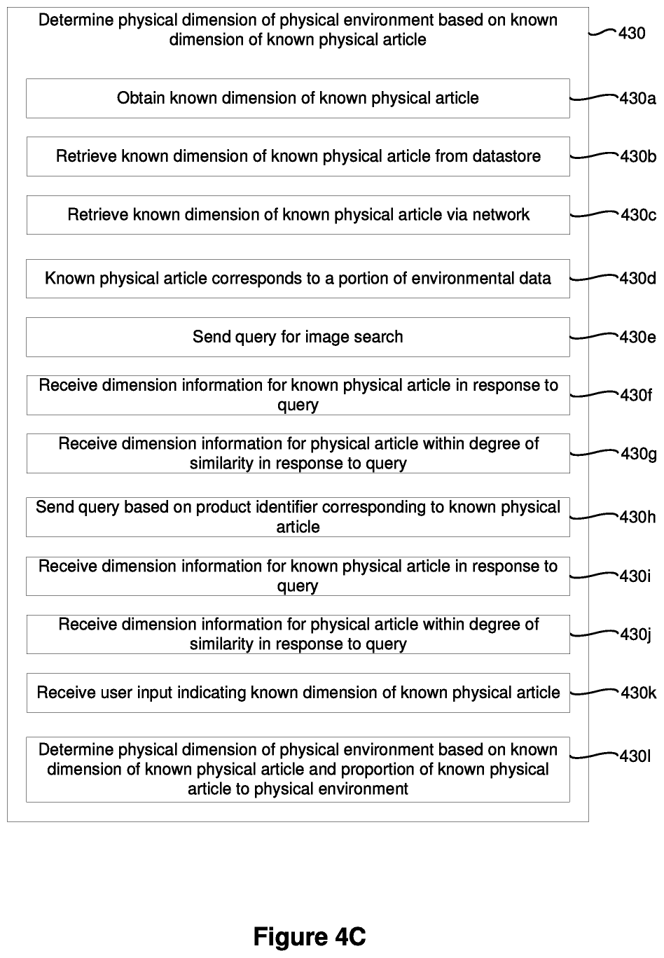

FIGS. 4A-4C are a flowchart representation of a method 400 for generating a CGR environment in accordance with some implementations. In various implementations, the method 400 is performed by a device (e.g., the electronic device 102 or the controller 104 shown in FIGS. 1A and 1B, or the system 200 shown in FIG. 2). In some implementations, the method 400 is performed by processing logic, including hardware, firmware, software, or a combination thereof. In some implementations, the method 400 is performed by a processor executing code stored in a non-transitory computer-readable medium (e.g., a memory). Briefly, in various implementations, the method 400 includes obtaining environmental data corresponding to a physical environment, identifying a known physical article located in the physical environment based on the environmental data, determining a physical dimension of the physical environment based on a known dimension of the known physical article, and generating a CGR environment representing the physical environment with a virtual dimension based on the physical dimension of the physical environment.

Referring to FIG. 4A, as represented by block 410, in various implementations, the method 400 includes obtaining environmental data corresponding to a physical environment. Referring to FIG. 4B, as represented by block 410a, the environmental data may include an image of the physical environment. In some implementations, the image is a still image. In some implementations, the image is an image frame forming part of a video feed. The image includes a plurality of pixels.

In some implementations, as represented by block 410b, the method 400 includes receiving the image of the physical environment from an image sensor, such as a camera. The image sensor may be characterized by a pose, e.g., a transformation that may be applied to a two-dimensional image captured by the image sensor to determine the three-dimensional physical environment represented by the image. In some implementations, as represented by block 410c, the pose of the image sensor is determined. As represented by block 410d, in some implementations, a scale factor is determined as a function of the pose. Determining the scale factor may facilitate correcting for apparent distortion of the image that may be attributable to the pose of the image sensor.

In some implementations, as represented by block 410e, the environmental data includes depth data. The depth data may be used independently of or in connection with the image to identify one or more objects in the physical environment. In some implementations, as represented by block 410f, the depth data is received from a depth sensor.

As represented by block 420, in some implementations, the method 400 includes identifying a known physical article located within the physical environment based on the environmental data. The known physical article is associated with a known dimension. In some implementations, for example, the known physical article is identified based on the image. In some implementations, the known physical article is identified based on the depth data.

As represented by block 420a, in some implementations, semantic segmentation and/or instance segmentation is performed on the environmental data to identify the known physical article. For example, in some implementations, a portion of the image, e.g., a first set of pixels, represents the known physical article. One or more filters and/or masks may be applied to the image to distinguish the first set of pixels from a second set of pixels that represents a background, e.g., a portion of the image that does not represent the known physical article. Semantic segmentation may be performed to associate the known physical article with a semantic label identifying a type of the known physical article, e.g., “chair.” Instance segmentation may be performed to associate the known physical article with a semantic label that distinguishes the known physical article from other physical articles of a similar type, e.g., “chair 1.” In some implementations, the semantic segmentation and/or instance segmentation generates a semantic label that identifies a model of the known physical article, e.g., a particular model of chair.

As represented by block 420b, in some implementations, the method 400 includes identifying an optical machine-readable representation of data associated with the known physical article. The optical machine-readable representation may be implemented, for example, as a barcode or a QR code. In some implementations, the optical machine-readable representation is part of the environmental data. In some implementations, the optical machine-readable representation is captured separately from the environmental data, e.g., during a subsequent scan and/or using a different sensor. In some implementations, the optical machine-readable representation identifies a model of the known physical article.

As represented by block 430, in some implementations, the method 400 includes determining a physical dimension of the physical environment based on the known dimension of the known physical article. Referring to FIG. 4C, as represented by block 430a, the method 400 may include obtaining the known dimension of the known physical article.

In some implementations, as represented by block 430b, the known dimension of the known physical article is retrieved from a datastore. For example, if the known physical article is a desk of a particular model, the datastore may return the length, width, and/or height of the particular model of desk. If the datastore does not have dimension information for the particular model of desk, the datastore may return dimension information for a similar model of desk or generalized dimension information for a generic (e.g., hypothetical) desk. The datastore may include dimension information for a plurality of known physical articles, e.g., a plurality of desk models and/or a generic desk.

In some implementations, as represented by block 430c, the known dimension of the known physical article is retrieved via a network, e.g., a service via a local area network (LAN) or the Internet. For example, if the known physical article is a desk of a particular model, the service may return the length, width, and/or height of the particular model of desk. If the service does not have dimension information for the particular model of desk, the service may return dimension information for a similar model of desk or generalized dimension information for a generic (e.g., hypothetical) desk. The service may include dimension information for a plurality of known physical articles, e.g., a plurality of desk models and/or a generic desk.

In some implementations, the known dimension of the known physical article is returned in response to a query. For example, in some implementations, the known physical article corresponds to a portion of the environmental data (e.g., a first set of pixels), as represented by block 430d. As represented by block 430e, the method 400 may include sending a query for an image search that is based on the portion of the environmental data to which the known physical article corresponds, e.g., the first set of pixels. In some implementations, as represented by block 430f, dimension information for the known physical article is received in response to the query. In some implementations, as represented by block 430g, dimension information is received for a physical article that is within a degree of similarity to the known physical article in response to the query. For example, if dimension information is not available for the particular model of desk indicated in the query, dimension information may be returned for a similar desk.

As represented by block 430h, the method 400 may include sending a query based on a product identifier corresponding to the known physical article. The product identifier may be a semantic label, for example. In some implementations, the product identifier identifies a particular model of the known physical article. In some implementations, as represented by block 430i, dimension information for the known physical article is received in response to the query. In some implementations, as represented by block 430j, dimension information is received for a physical article that is within a degree of similarity to the known physical article in response to the query. For example, if dimension information is not available for the particular model of desk indicated in the query, dimension information may be returned for a similar desk.

In some implementations, as represented by block 430k, the method 400 includes receiving a user input indicating the known dimension of the known physical article. For example, a user may provide a user input indicating a length, width, and/or height of a desk using a keyboard, mouse, and/or gesture controls on a touchscreen interface.

In some implementations, as represented by block 430l, the physical dimension of the physical environment is determined based on the known dimension of the known physical article and a proportion of the known physical article to the physical environment. For example, the known physical article may be a desk located along a wall of an office, and the known dimension of the desk may be a width of two meters. If the proportion of the width of the desk to the wall is 1:2 (e.g., the desk occupies half of the wall along which the desk is located), the dimension determiner 330 may determine that the wall along which the desk is located is four meters long. In some implementations, the dimension determiner 330 determines other physical dimensions of the physical environment based on this determination. For example, if the height of the wall is three-fourths of the length of the wall, the dimension determiner 330 may determine that the wall is three meters high.

In some implementations, as represented by block 440, the method 400 includes generating a CGR environment that represents the physical environment. In some implementations, the CGR environment has a virtual dimension, e.g., a number of pixels. The virtual dimension is a function of the physical dimension of the physical environment. For example, in some implementations, the environment generator 340 determines a number of pixels to use in rendering the physical dimension of the physical environment.

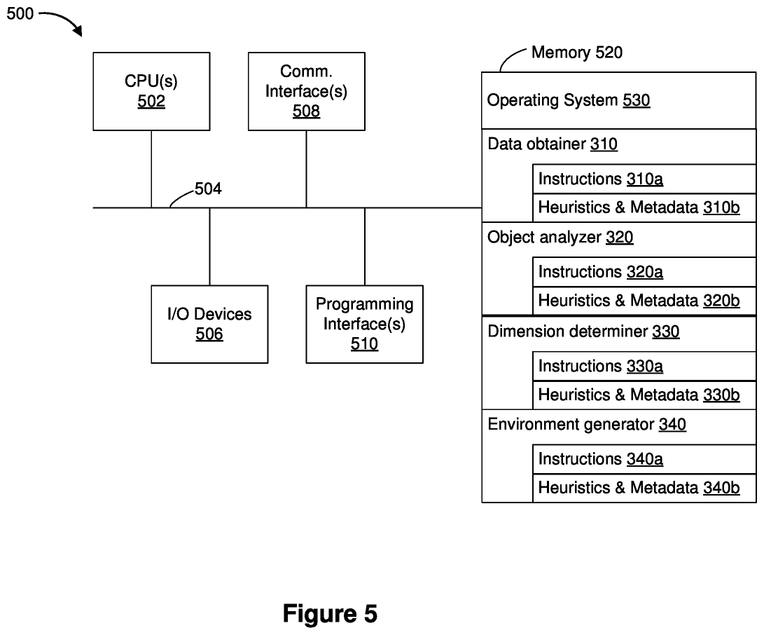

FIG. 5 is a block diagram of a device 500 enabled with one or more components of a device (e.g., the electronic device 102 and/or the controller 104 shown in FIGS. 1A and 1B, or the system 200 shown in FIG. 2) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units (CPUs) 502, one or more input/output (I/O) devices 506, one or more communication interface(s) 508, one or more programming interface(s) 510, a memory 520, and one or more communication buses 504 for interconnecting these and various other components.

In some implementations, the communication interface 508 is provided to, among other uses, establish, and maintain a metadata tunnel between a cloud-hosted network management system and at least one private network including one or more compliant devices. In some implementations, the one or more communication buses 504 include circuitry that interconnects and controls communications between system components. The memory 520 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 520 optionally includes one or more storage devices remotely located from the one or more CPUs 502. The memory 520 comprises a non-transitory computer readable storage medium.

In some implementations, the memory 520 or the non-transitory computer readable storage medium of the memory 520 stores the following programs, modules and data structures, or a subset thereof including an optional operating system 530, the data obtainer 310, the object analyzer 320, the dimension determiner 330, and the environment generator 340. As described herein, the data obtainer 310 may include instructions 310a and/or heuristics and metadata 310b for obtaining environmental data corresponding to a physical environment. As described herein, the object analyzer 320 may include instructions 320a and/or heuristics and metadata 320b for identifying a known physical article in the physical environment based on the environmental data. As described herein, the dimension determiner 330 may include instructions 330a and/or heuristics and metadata 330b for determining a physical dimension of the physical environment based on the known dimension of the known physical article. As described herein, the environment generator 340 may include instructions 340a and/or heuristics and metadata 340b for generating a CGR environment that represents the physical environment.

In some implementations, the one or more I/O devices 506 include an environmental sensor for capturing environmental data. In some implementations, the environmental sensor includes an image sensor (e.g., a camera) for capturing image data representing a set of one or more images. In some implementations, the environmental sensor includes a depth sensor (e.g., a depth camera) for capturing depth data. In some implementations, the one or more I/O devices 506 include a display for displaying a CGR environment. In some implementations, the display includes an optical see-through display (e.g., for displaying an optical pass-through of a physical environment). In some implementations, the display includes an opaque display (e.g., for displaying a video pass-through of a physical environment).

It will be appreciated that FIG. 5 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 5 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

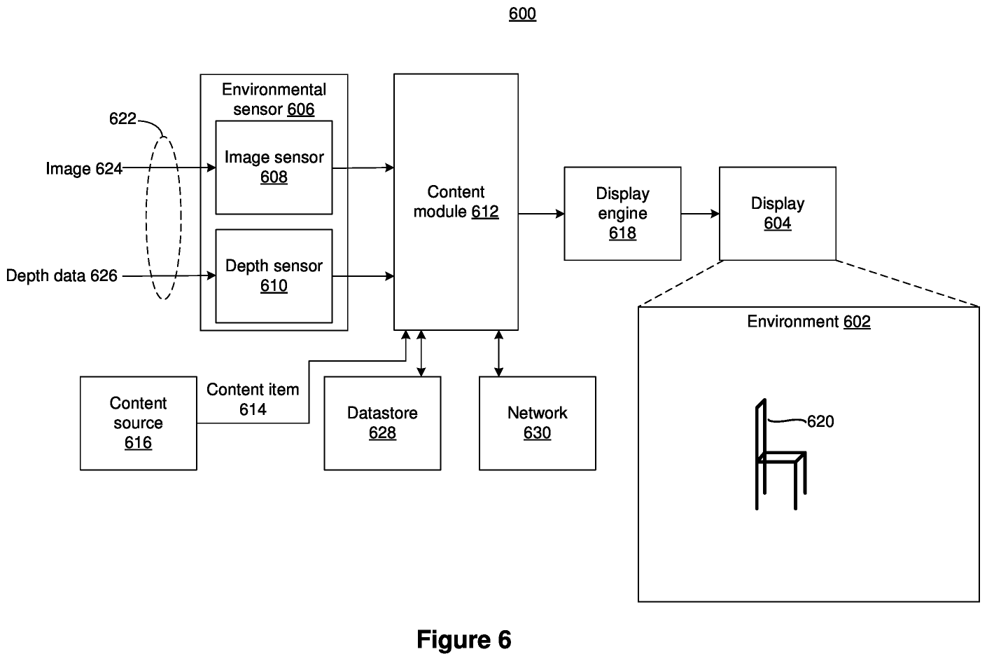

FIG. 6 illustrates an example system 600 that displays a CGR object in an augmented reality (AR) environment 602 according to various implementations. In some implementations, a display 604 displays the AR environment 602. In some implementations, the display 604 is implemented as part of the electronic device 102. In some implementations, the display 604 is implemented as part of an HMD.

In some implementations, the AR environment 602 corresponds to a physical environment. For example, the AR environment 602 may be rendered as an optical pass-through of the physical environment in which one or more CGR objects are rendered with the physical environment as a background, e.g., overlaid over the physical environment. In some implementations, an environmental sensor 606 (e.g., including an image sensor 608 and/or a depth sensor 610) obtains image data corresponding to the physical environment, and the AR environment 602 is rendered as a video pass-through of the physical environment. In a video pass-through, the display 604 displays one or more CGR objects with a CGR representation of the physical environment.

In some implementations, a CGR content module 612 generates the AR environment 602. In some implementations, the CGR content module 612 obtains CGR content, e.g., a CGR content item 614, from a CGR content source 616. The CGR content item 614 may include the AR environment 602. In some implementations, the CGR content module 612 provides the CGR content item 614 including the AR environment 602 to a display engine 618, which prepares the CGR content item 614 for output using the display 604.

In some implementations, the CGR content module 612 determines to display a CGR object 620 in the AR environment 602. The CGR object 620 corresponds to a physical object having a physical dimension. For example, the CGR object 620 may correspond to a physical chair having a physical height, width, and/or length. In some implementations, the physical object to which the CGR object 620 corresponds is present in the physical environment. In some implementations, the physical object to which the CGR object 620 corresponds is not present in the physical environment. In either case, it is desirable to render the CGR object 620 with appropriate scaling, e.g., so that the CGR object 620 is proportionate with other features of the AR environment 602.

In some implementations, the CGR content module 612 identifies a known physical article located in the physical environment. In some implementations, the environmental sensor 606 obtains environmental data 622 corresponding to the physical environment. For example, in some implementations, the image sensor 608 obtains an image 624 of the environment.

In some implementations, the image 624 is a still image. In some implementations, the image 624 is an image frame forming part of a video feed. The image 624 includes a plurality of pixels. Some of the pixels, e.g., a first set of pixels, represent an object. Other pixels, e.g., a second set of pixels, represent a background, e.g., portions of the image 624 that do not represent the object. It will be appreciated that pixels that represent one object may represent the background for a different object.

In some implementations, the depth sensor 610 obtains depth data 626 corresponding to the environment. The depth data 626 may be used independently of or in connection with the image 624 to identify the known physical article.

In some implementations, the CGR content module 612 receives the environmental data 622 from the environmental sensor 606. In some implementations, the CGR content module 612 identifies a known physical article in the physical environment based on the environmental data 606. For example, the CGR content module 612 may perform semantic segmentation and/or instance segmentation on the environmental data 606 to identify the known physical article. In some implementations, the environmental data 606 includes an image, and the CGR content module 612 applies one or more filters and/or masks to the image to characterize pixels in the image as being associated with respective objects, such as the known physical article.

In some implementations, the image sensor 608 reads (e.g., detects) an optical machine-readable representation (e.g., a barcode or a QR code) of data associated with the known physical article. The CGR content module 612 may send a query, e.g., to a product database to obtain information identifying the known physical article.

The known physical article is associated with a known dimension. In some implementations, the CGR content module 612 obtains dimension information for the known physical article. For example, the CGR content module 612 may send a query including information identifying the known physical article to a datastore 628 or to a service via a network 630, such as a local area network (LAN) or the Internet. In some implementations, the information identifying the known physical article includes a semantic label, a product identifier, and/or an image. In response to the query, the CGR content module 612 may receive dimension information for the known physical article. In some implementations, if dimension information for the known physical article is not available, the CGR content module 612 receives dimension information for a physical article that is within a degree of similarity to the known physical article.

In some implementations, the CGR content module 612 determines a virtual dimension for the CGR object 620 based on the known dimension of the known physical article and the physical dimension of the physical article that the CGR object 620 represents. For example, if the CGR object 620 is a CGR chair and the known physical article is an electrical outlet, the CGR content module 612 may determine a virtual height for the CGR chair based on a physical height of a physical chair represented by the CGR chair and a known physical height of the electrical outlet. For example, if the electrical outlet is four inches tall and the physical chair is 20 inches tall (e.g., five times as tall as the electrical outlet), the CGR content module 612 may determine that the virtual height for the CGR chair is five times the height of the electrical outlet. In some implementations, when the CGR chair is displayed next to the electrical outlet, the CGR chair occupies a height of five times the number of pixels relative to the number of pixels occupied by the electrical outlet.

In some implementations, the CGR content module 612 scales the virtual dimension of the CGR object 620 based on at least one of a number of factors. For example, in some implementations, the CGR content module 612 scales the virtual dimension of the CGR object 620 based on a known dimension of a known physical article, e.g., a height of an electrical outlet. In some implementations, the CGR content module 612 scales the virtual dimension of the CGR object 620 based on a distance of the known physical article from a device in which the system 600 is implemented. In some implementations, the CGR content module 612 scales the virtual dimension of the CGR object 620 based on a physical dimension of a physical article (e.g., a physical height of a physical chair) corresponding to the CGR object 620. In some implementations, the CGR content module 612 scales the virtual dimension of the CGR object 620 based on a placement location of the CGR object 620 within the AR environment 602, e.g., a distance at which the CGR object 620 is to be placed from the user.

In some implementations, the CGR content module 612 displays the CGR object 620 in the AR environment 602 in accordance with the virtual dimension. For example, if the CGR content module 612 determines that the virtual height of the CGR object 620 is five times the height of the known physical object, the CGR content module 612 may display the CGR object 620 with a virtual height occupying five times the pixels relative to the height of the known physical object.

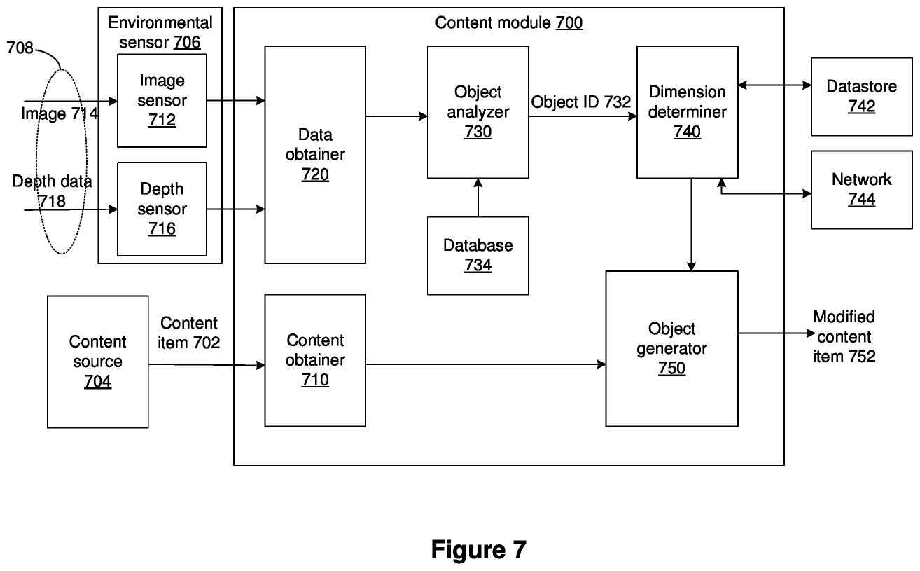

FIG. 7 is a block diagram of an example CGR content module 700 in accordance with some implementations. In some implementations, the CGR content module 700 implements the CGR content module 612 shown in FIG. 6. In some implementations, a CGR content obtainer 710 obtains CGR content, e.g., a CGR content item 702, to display using a display, such as the display 604 of FIG. 6. The CGR content item 702 may include an AR environment that corresponds to a physical environment. In some implementations, the CGR content obtainer 710 generates the CGR content item 702, including the AR environment. In some implementations, the CGR content obtainer 710 obtains the CGR content item 702 from a CGR content source 704.

In some implementations, the CGR content obtainer 710 determines to display a CGR object in the AR environment. For example, the CGR content obtainer 710 may obtain a CGR object from the CGR content source 704 or from another source. The CGR object corresponds to a physical object having a physical dimension. For example, the CGR object may be a representation of a physical chair having a physical height, width, and/or length. The physical object to which the CGR object corresponds may or may not be present in the physical environment. In either case, it is desirable to render the CGR object with appropriate scaling, e.g., so that the CGR object is proportionate with other features of the AR environment.

In some implementations, the CGR content module 700 identifies a known physical article located in the physical environment. In some implementations, an environmental sensor 706 obtains environmental data 708 corresponding to the physical environment and provides the environmental data 708 to a data obtainer 720. In some implementations, the environmental sensor 706 includes an image sensor 712 (e.g., a camera) that obtains an image 714 of the physical environment. In some implementations, the environmental sensor 706 includes a depth sensor 716 that obtains depth data 718 corresponding to the physical environment. The depth data 718 may be used independently of or in connection with the image 714 to identify the known physical article.

In some implementations, the image 714 is a still image. In some implementations, the image 714 is an image frame forming part of a video feed. The image 714 includes a plurality of pixels. Some of the pixels, e.g., a first set of pixels, represent an object. Other pixels, e.g., a second set of pixels, represent a background, e.g., portions of the image 714 that do not represent the object. It will be appreciated that pixels that represent one object may represent the background for a different object.

In some implementations, an object analyzer 730 identifies a known physical article in the physical environment based on the environmental data 708. The known physical article is associated with a known physical dimension according to which the CGR object may be scaled. In some implementations, the object analyzer 730 performs semantic segmentation and/or instance segmentation on the environmental data 708 to identify the known physical article. In some implementations, the environmental data 708 includes the image 714, and the object analyzer 730 applies one or more filters and/or masks to the image 714 to characterize pixels in the image 714 as being associated with respective objects, such as the known physical article. In some implementations, the known physical article is represented by a portion of the image 714, and the object analyzer 730 performs semantic segmentation and/or instance segmentation on that portion of the image 714 to identify the known physical article.

In some implementations, the data obtainer 720 may obtain an optical machine-readable representation of data associated with a known physical article. The optical machine-readable representation may be implemented, for example, as a barcode or a QR code. In some implementations, the optical machine-readable representation is part of the image 714. In some implementations, the optical machine-readable representation is captured separately from the image 714, e.g., in a separate scan.

In some implementations, the object analyzer 730 determines an object identifier 732, such as a semantic label and/or a product identifier, that identifies the known physical article. In some implementations, the object analyzer 730 determines the object identifier 732 for the known physical article based on available information relating to a physical article corresponding to the known physical article or within a degree of similarity to the known physical article. This information can be obtained from one or more sources.

For example, in some implementations, the object analyzer 730 determines the object identifier 732 based on information received from a database 734 (e.g., a local database). For example, the database 734 may store a product specification for a physical article (e.g., a chair) corresponding to the known physical article (e.g., of the same model of the known physical article). In some implementations, the database 734 stores a product specification for a physical article that is within a degree of similarity to the known physical article. For example, if a product specification is not available for the same model of chair corresponding to the known physical article, the object analyzer 730 may use a product specification for a similar model of chair.

The known physical article is associated with a known dimension. In some implementations, a dimension determiner 740 obtains dimension information for the known physical article. For example, the dimension determiner 740 may send a query including information identifying the known physical article to a datastore 742 or to a service via a network 744, such as a local area network (LAN) or the Internet. In some implementations, the information identifying the known physical article includes a semantic label, a product identifier, and/or an image. In response to the query, the dimension determiner 740 may receive dimension information for the known physical article. For example, if the known physical article is a standard electrical outlet, the dimension determiner 740 may receive information indicating that the height of a standard electrical outlet is four inches. In some implementations, if dimension information for the known physical article is not available, the dimension determiner 740 receives dimension information for a physical article that is within a degree of similarity to the known physical article.

In some implementations, the dimension determiner 740 determines a virtual dimension for the CGR object based on the known dimension of the known physical article and the physical dimension of the physical article that the CGR object represents. For example, if the CGR object is a CGR chair and the known physical article is an electrical outlet, the dimension determiner 740 may determine a virtual height for the CGR chair based on a physical height of a physical chair represented by the CGR chair and a known physical height of the electrical outlet.

In some implementations, the dimension determiner 740 scales the virtual dimension of the CGR object based on at least one of a number of factors. In some implementations, the dimension determiner 740 scales the virtual dimension of the CGR object based on a known dimension of a known physical article, e.g., a height of an electrical outlet. For example, if the electrical outlet is four inches tall and the physical chair is 20 inches tall (e.g., five times as tall as the electrical outlet), the dimension determiner 740 may determine that the virtual height for the CGR chair is five times the height of the electrical outlet. In some implementations, when the CGR chair is displayed next to the electrical outlet, the CGR chair occupies a height of five times the pixels relative to the number of pixels occupied by the electrical outlet.

In some implementations, the dimension determiner 740 scales the virtual dimension of the CGR object based on a distance of the known physical article from a device in which the CGR content module 700 is implemented. For example, if the CGR content module 700 is implemented in an HMD that is located at the opposite side of a room relative to the electrical outlet, the electrical outlet may occupy fewer pixels in the display of the AR environment. Accordingly, scaling the CGR object relative to the electrical outlet may cause the CGR object to appear smaller than it would if the electrical outlet were closer to the HMD. In some implementations, the dimension determiner 740 accounts for the distance of the known physical article from the device when determining the virtual dimension of the CGR object, e.g., to compensate for this potential effect.

In some implementations, the dimension determiner 740 scales the virtual dimension of the CGR object based on a physical dimension of a physical article corresponding to the CGR object. For example, if the CGR object is a representation of a physical chair, the dimension determiner 740 may scale the virtual height of the CGR object based on the physical height of the physical chair. The physical height of the physical article may be determined, for example, by sending a query identifying the physical article to the datastore 742 or to a service via the network 744.

In some implementations, the dimension determiner 740 scales the virtual dimension of the CGR object based on a placement location of the CGR object within the AR environment, e.g., a distance at which the CGR object is to be placed from the user. For example, if the CGR object is to be placed far from the user, the dimension determiner 740 may scale the CGR object to appear smaller. Conversely, if the CGR object is to be placed close to the user, the dimension determiner 740 may scale the CGR object to appear larger.

In some implementations, the CGR content module 700 displays the CGR object in the AR environment in accordance with the virtual dimension. In some implementations, an object generator 750 generates a modified CGR content item 752 that includes the CGR object instantiated within the AR environment consistent with the virtual dimension. For example, if the dimension determiner 740 determines that the virtual height of the CGR object is five times the height of the known physical object, the object generator 750 may instantiate the CGR object with a virtual height occupying five times the number of pixels relative to the height of the known physical object.

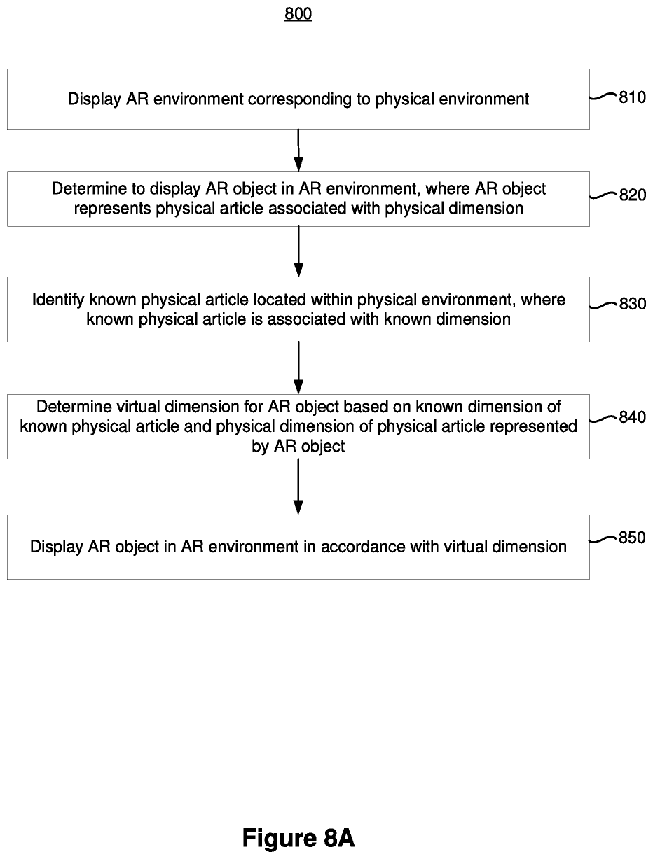

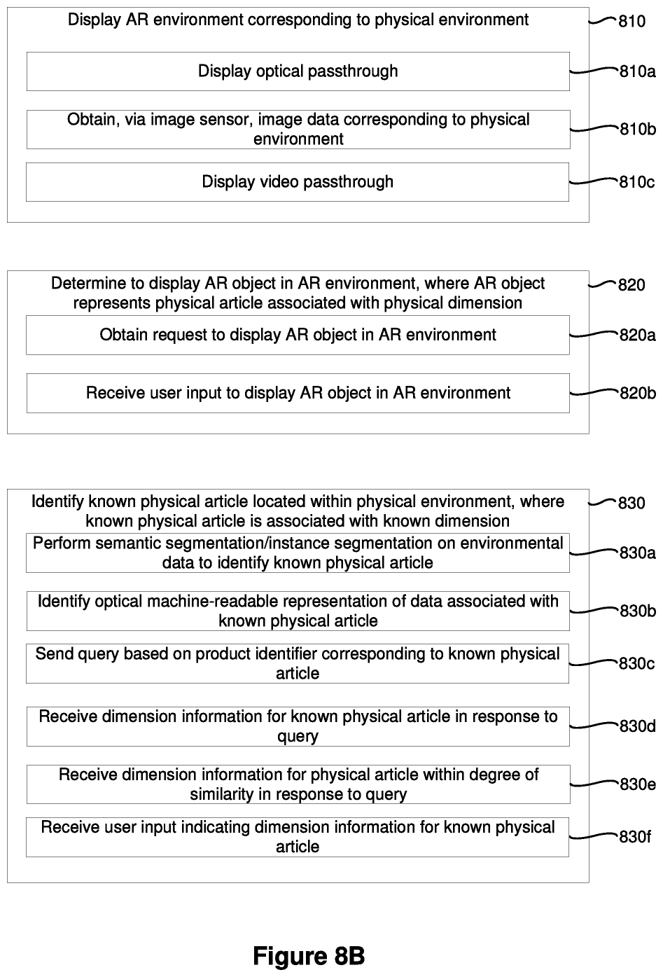

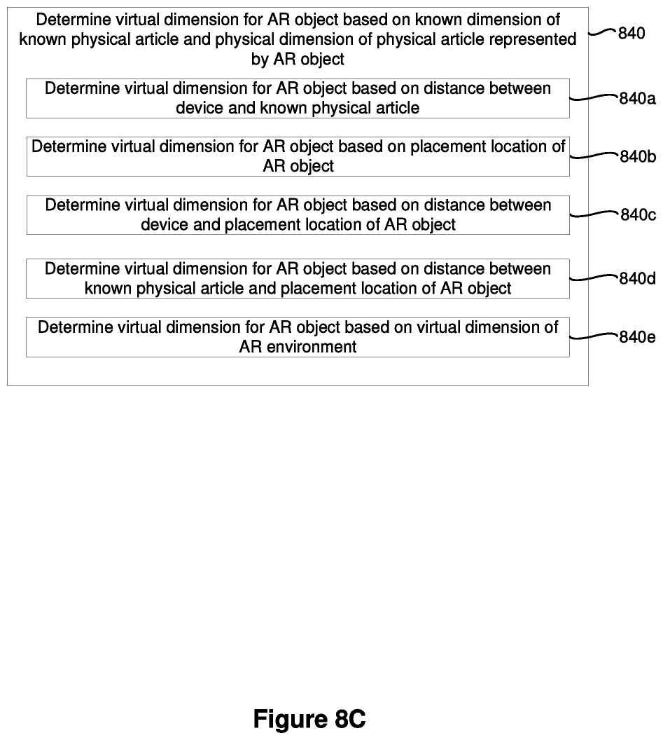

FIGS. 8A-8C are a flowchart representation of a method 800 for displaying a CGR object in an AR environment in accordance with some implementations. In various implementations, the method 800 is performed by a device (e.g., the electronic device 102 and/or the controller 104 shown in FIGS. 1A and 1B, or the system 600 shown in FIG. 6). In some implementations, the method 800 is performed by processing logic, including hardware, firmware, software, or a combination thereof. In some implementations, the method 800 is performed by a processor executing code stored in a non-transitory computer-readable medium (e.g., a memory). Briefly, in various implementations, the method 800 includes displaying an AR environment that corresponds to a physical environment; determining to display a CGR object in the AR environment, identifying a known physical article located within the physical environment, determining a virtual dimension for the CGR object based on a known dimension of the known physical article and a physical dimension of the physical article represented by the CGR object, and displaying the CGR object in the AR environment in accordance with the virtual dimension.

Referring to FIG. 8A, as represented by block 810, in various implementations, the method 800 includes displaying an AR environment that corresponds to a physical environment. Referring to FIG. 8B, as represented by block 810a, the AR environment 602 may be rendered as an optical pass-through of the physical environment in which one or more CGR objects are rendered with the physical environment as a background, e.g., overlaid over the physical environment as perceived through, for example, a lens in an HMD.

As represented by block 810b, in some implementations, an image sensor, such as a camera, obtains image data corresponding to the physical environment. The AR environment is rendered as a video pass-through of the physical environment, as represented by block 810c. In a video pass-through, a device displays one or more CGR objects with a CGR representation of the physical environment.

As represented by block 820, in various implementations, the method 800 includes determining to display a CGR object in the AR environment. The CGR object represents a physical article associated with a physical dimension. For example, the CGR object may represent a physical chair associated with a physical height.

In some implementations, as represented by block 820a, a request is obtained to display the CGR object in the AR environment. The request may be received from a user. For example, in some implementations, as represented by block 820b, a user input is received to display the CGR object in the AR environment. The user input may include, for example, an input from a mouse, a keyboard, and/or a gesture-based input from a touchscreen interface. In some implementations, the request is generated by a process or an application without any intervention from the user.

In some implementations, as represented by block 830, the method 800 includes identifying a known physical object located within the physical environment. The known physical object is associated with a known dimension. In some implementations, as represented by block 830a, semantic segmentation and/or instance segmentation are performed on environmental data to identify the known physical article. In some implementations, the environmental data includes an image captured by an image sensor, such as a camera. One or more filters and/or masks may be applied to the image to characterize pixels in the image as being associated with respective objects, such as the known physical article. In some implementations, the known physical article is represented by a portion of the image, and the semantic segmentation and/or instance segmentation are performed on that portion of the image to identify the known physical article.

In some implementations, as represented by block 830b, an optical machine-readable representation of data associated with the known physical article is identified. The optical machine-readable representation may be implemented, for example, as a barcode or a QR code.

In some implementations, a query is sent, e.g., to a product database to obtain information identifying the known physical article. In some implementations, the information identifying the known physical article includes a semantic label, a product identifier, and/or an image. As represented by block 830c, the query may be sent based on a product identifier corresponding to the known physical article. For example, if the optical machine-readable representation of data includes a model number or a uniform product code (UPC) identifier corresponding to the known physical article, the query may include that information. In some implementations, as represented by block 830d, the method 800 includes receiving, in response to the query, dimension information for the known physical article. For example, the product database may return the height of a particular model of electrical outlet from a specific manufacturer, if that information is available. In some implementations, as represented by block 830e, the method 800 includes receiving, in response to the query, dimension information for a physical article that is within a degree of similarity to the known physical article. For example, if the product database does not have information for a particular type of electrical outlet, the product database may instead return the height of a generalized electrical outlet, e.g., an average across manufacturers or a standard height. In some implementations, as represented by block 830f, the method 800 includes receiving a user input indicating dimension information for the known physical article. For example, a user may provide a user input indicating a width and/or a height of the electrical outlet using a keyboard, mouse, and/or gesture controls on a touchscreen interface.

In some implementations, as represented by block 840, the method 800 includes determining a virtual dimension for the CGR object based on the known dimension of the known physical article and the physical dimension of the physical article that the CGR object represents. For example, if the CGR object is a CGR chair and the known physical article is an electrical outlet, the virtual height for the CGR chair may be based on a physical height of a physical chair represented by the CGR chair and a known physical height of the electrical outlet.

In some implementations, the dimension determiner 740 scales the virtual dimension of the CGR object based on at least one of a number of factors. In some implementations, the virtual dimension of the CGR object is based on a known dimension of a known physical article, e.g., a height of an electrical outlet. For example, if the electrical outlet is four inches tall and the physical chair is 20 inches tall (e.g., five times as tall as the electrical outlet), the virtual height for the CGR chair is five times the height of the electrical outlet. In some implementations, when the CGR chair is displayed next to the electrical outlet, the CGR chair occupies a height of five times the pixels relative to the number of pixels occupied by the electrical outlet.

Referring now to FIG. 8C, as represented by block 840a, the virtual dimension of the CGR object may be scaled based on a distance of the known physical article from a device in which the system 600 is implemented. For example, if the system 600 is implemented in an HMD that is located at the opposite side of a room relative to the electrical outlet, the electrical outlet may occupy fewer pixels in the display of the AR environment. Accordingly, scaling the CGR object relative to the electrical outlet may cause the CGR object to appear smaller than it would if the electrical outlet were closer to the HMD. In some implementations, the scaling of the CGR object accounts for the distance of the known physical article from the device, e.g., to compensate for this potential effect.

In some implementations, as represented by block 840b, the virtual dimension of the CGR object is scaled based on a placement location of the CGR object within the AR environment, e.g., a distance at which the CGR object is to be placed from the user. The user may be assumed to be substantially collocated with the device. In some implementations, as represented by block 840c, the virtual dimension of the CGR object is determined based on a distance between the device and a placement location of the CGR object. For example, if the CGR object is to be placed far from the user, the CGR object may be scaled to appear smaller. Conversely, if the CGR object is to be placed close to the user, the CGR object may be scaled to appear larger.

In some implementations, as represented by block 840d, the virtual dimension of the CGR object is determined based on a distance between the known physical article and a placement location of the CGR object. For example, if the CGR object is to be placed close to the known physical article, the virtual dimension of the CGR object may be scaled according to the known dimension of the known physical article. In some implementations, if the CGR object is to be placed far from the known physical article in the AR environment, an additional scaling factor may be used to compensate for apparent size differences due to perspective.

In some implementations, as represented by block 840e, the virtual dimension of the CGR object is determined based on a virtual dimension of the AR environment. For example, in an AR environment corresponding to a two-car garage, a CGR object representing a car may be scaled to have a virtual width based on approximately half the virtual width of the AR environment.

In some implementations, as represented by block 850, the method 800 includes displaying the CGR object in the AR environment in accordance with the virtual dimension. In some implementations, a modified CGR content item is generated. The modified CGR content item includes the CGR object instantiated within the AR environment consistent with the virtual dimension. For example, if the virtual height of the CGR object is five times the height of the known physical object, the CGR object may be instantiated within the AR environment with a virtual height occupying five times the number of pixels relative to the height of the known physical object.

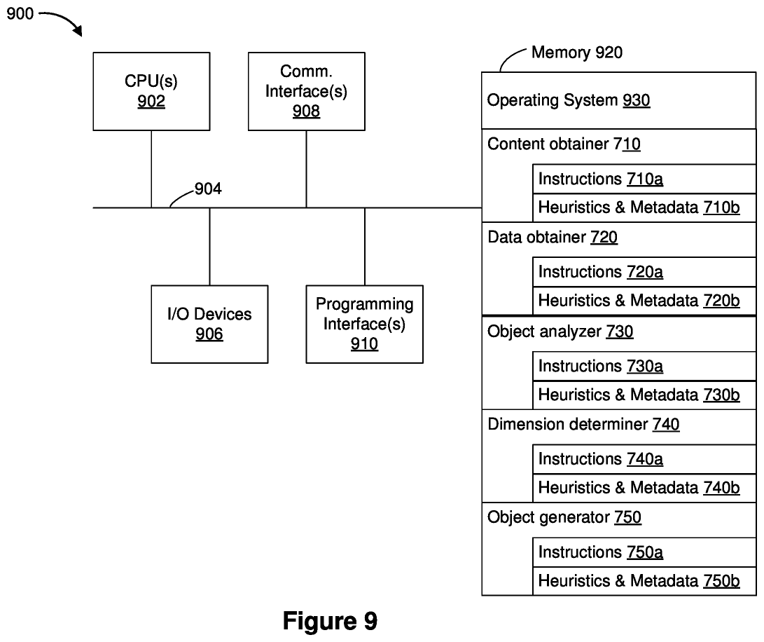

FIG. 9 is a block diagram of a device 900 enabled with one or more components of a device (e.g., the electronic device 102 and/or the controller 104 shown in FIGS. 1A and 1B, or the system 600 shown in FIG. 6) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the server system 900 includes one or more processing units (CPUs) 902, one or more input/output (I/O) devices 906, one or more communication interface(s) 908, one or more programming interface(s) 910, a memory 920, and one or more communication buses 904 for interconnecting these and various other components.

In some implementations, the communication interface 908 is provided to, among other uses, establish, and maintain a metadata tunnel between a cloud-hosted network management system and at least one private network including one or more compliant devices. In some implementations, the one or more communication buses 904 include circuitry that interconnects and controls communications between system components. The memory 920 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 920 optionally includes one or more storage devices remotely located from the one or more CPUs 902. The memory 920 comprises a non-transitory computer readable storage medium.

In some implementations, the memory 920 or the non-transitory computer readable storage medium of the memory 920 stores the following programs, modules and data structures, or a subset thereof including an optional operating system 930, the CGR content obtainer 710, the data obtainer 720, the object analyzer 730, the dimension determiner 740, and the object generator 750. As described herein, the CGR content obtainer 710 may include instructions 710a and/or heuristics and metadata 710b for obtaining CGR content to display, including an AR environment. As described herein, the data obtainer 720 may include instructions 720a and/or heuristics and metadata 720b for obtaining environmental data corresponding to a physical environment. As described herein, the object analyzer 730 may include instructions 730a and/or heuristics and metadata 730b for identifying a known physical article in the physical environment based on the environmental data. As described herein, the dimension determiner 740 may include instructions 740a and/or heuristics and metadata 740b for determining a known dimension of the known physical article and/or for determining a physical dimension of the physical environment based on the known dimension of the known physical article. As described herein, the object generator 750 may include instructions 750a and/or heuristics and metadata 750b for generating a CGR object in the AR environment.

In some implementations, the one or more I/O devices 906 include an environmental sensor for capturing environmental data. In some implementations, the environmental sensor includes an image sensor (e.g., a camera) for capturing image data representing a set of one or more images. In some implementations, the environmental sensor includes a depth sensor (e.g., a depth camera) for capturing depth data. In some implementations, the one or more I/O devices 906 include a display for displaying a CGR environment. In some implementations, the display includes an optical see-through display (e.g., for displaying an optical pass-through of a physical environment). In some implementations, the display includes an opaque display (e.g., for displaying a video pass-through of a physical environment).

It will be appreciated that FIG. 9 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 9 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a non-transitory memory and one or more processors coupled with the non-transitory memory:
obtaining environmental data corresponding to a physical environment;
identifying a known physical article located within the physical environment based on the environmental data, wherein the known physical article is associated with a known dimension;
determining a physical dimension of the physical environment based on the known dimension of the known physical article; and
generating a computer-generated reality (CGR) environment that represents the physical environment, wherein a virtual dimension of the CGR environment is a function of the physical dimension of the physical environment.

2. The method of claim 1, wherein obtaining the environmental data comprises receiving an image of the physical environment from an image sensor.

3. The method of claim 2, further comprising determining a pose of the image sensor and determining a scaling factor as a function of the pose.

4. The method of claim 1, wherein obtaining the environmental data comprises receiving depth data from a depth sensor.

5. The method of claim 1, further comprising performing at least one of semantic segmentation or instance segmentation on the environmental data to identify the known physical article.

6. The method of claim 1, further comprising identifying an optical machine-readable representation of data associated with the known physical article.

7. The method of claim 1, further comprising obtaining the known dimension of the known physical article.

8. The method of claim 1, wherein the known physical article corresponds to a portion of the environmental data.

9. The method of claim 8, further comprising:
sending a query for an image search based on the portion of the environmental data to which the known physical article corresponds; and
receiving, in response to the query, dimension information for the known physical article or dimension information for a physical article within a similarity threshold of the known physical article.

10. The method of claim 1, further comprising:
sending a query based on a product identifier corresponding to the known physical article; and
receiving, in response to the query, dimension information for the known physical article or dimension information for a physical article within a similarity threshold of the known physical article.

11. The method of claim 1, further comprising receiving a user input indicating the known dimension of the known physical article.

12. The method of claim 1, further comprising determining the physical dimension of the physical environment based on the known dimension of the known physical article and a proportion of the known physical article to the physical environment.

13. A device comprising:
an environmental sensor;
a display;
one or more processors;
a non-transitory memory; and
one or more programs stored in the non-transitory memory, which, when executed by the one or more processors, cause the device to:
obtain, via the environmental sensor, environmental data corresponding to a physical environment;
identify a known physical article located within the physical environment based on the environmental data, wherein the known physical article is associated with a known dimension;
determine a physical dimension of the physical environment based on the known dimension of the known physical article; and
generate a computer-generated reality (CGR) environment that represents the physical environment, wherein a virtual dimension of the CGR environment is a function of the physical dimension of the physical environment.

14. The device of claim 13, wherein obtaining the environmental data comprises receiving an image of the physical environment from an image sensor.

15. The device of claim 14, wherein the one or more programs further cause the device to determine a pose of the image sensor and determine a scale factor as a function of the pose.

16. The device of claim 13, wherein obtaining the environmental data comprises receiving depth data from a depth sensor.

17. The device of claim 13, wherein the one or more programs further cause the device to perform at least one of semantic segmentation or instance segmentation on the environmental data to identify the known physical article.

18. The device of claim 13, wherein the one or more programs further cause the device to identify an optical machine-readable representation of data associated with the known physical article.

19. The device of claim 13, wherein the one or more programs further cause the device to obtain the known dimension of the known physical article.

20. A non-transitory memory storing one or more programs, which, when executed by one or more processors of a device, cause the device to:
obtain, via an environmental sensor, environmental data corresponding to a physical environment;
identify a known physical article located within the physical environment based on the environmental data, wherein the known physical article is associated with a known dimension;
determine a physical dimension of the physical environment based on the known dimension of the known physical article; and
generate a computer-generated reality (CGR) environment that represents the physical environment, wherein a virtual dimension of the CGR environment is a function of the physical dimension of the physical environment.
